(19) United States
(12) Patent Application Publication
(10) Pub. No.: US 2025/0338063 A1
(43) Pub. Date: Oct. 30, 2025

(54) ANHARMONICALLY DRIVEN LOUDSPEAKER AS PUMP FOR CREATING NET AIRFLOW THROUGH CAVITY

(71) Applicant: Apple Inc., Cupertino, CA (US)

(72) Inventors: Matthias IKEDA, Cupertino, CA (US); Krishna Prasad VUMMIDI MURALI, Sunnyvale, CA (US); Michael A. LEHR, Saratoga, CA (US); Patrick R. GILL, Victoria (CA)

(21) Appl. No.: 19/189,073

(22) Filed: Apr. 24, 2025

Related U.S. Application Data
(60) Provisional application No. 63/638,840, filed on Apr. 25, 2024.

(51) Int. Cl. H04R 3/00; H04R 1/02; H04R 29/00

(52) U.S. Cl. CPC H04R 3/00; H04R 1/023; H04R 1/025; H04R 29/001

(57) ABSTRACT

An electronic device includes a cavity and a loudspeaker disposed at least partially in the cavity. In some examples, the cavity includes a first port and a second port, where the first port has a first pneumatic resistance and the second port has a second pneumatic resistance, different from the first pneumatic resistance, at different wind speeds. In some examples, the loudspeaker is configured to be driven by an anharmonic function to induce a turbulent airflow, resulting in air entering the cavity through the first port and exiting the cavity through the second port.

### CROSS REFERENCE TO RELATED APPLICATIONS

This application claims the benefit of U.S. Provisional Application No. 63/638,840, filed Apr. 25, 2024, the content of which is herein incorporated by reference in its entirety for all purposes.

### FIELD OF THE DISCLOSURE

This relates generally to electronic devices and more specifically to systems and methods for managing airflow within the cavities of such devices.

BACKGROUND OF THE DISCLOSURE

Electronic devices often use fans or valves to circulate air within the device's internal cavities to regulate temperature or removing moisture. These methods can add to the complexity, cost, and power consumption of device.

### SUMMARY OF THE DISCLOSURE

This relates to an electronic device with an airflow management system. In some examples, the device includes a cavity with two (or more) ports with different pneumatic resistances. In some examples, a loudspeaker, driven by an anharmonic function, induces turbulent airflow within the cavity. In some examples, the device utilizes a difference between the differential pneumatic resistance between the ports at various air speeds to generate net airflow through the cavity, leveraging variations in air speed for environmental conditioning.

In some examples, the different pneumatic resistances at various air speeds can be achieved using meshed versus non-meshed ports, meshed ports with different mesh densities, different airflow paths between ports, and/or different sized ports. In some examples, one or more sensors placed within the cavity enable monitoring of one or more environmental conditions. Data from the one or more sensors may cause operational adjustments for the device, such as displacing liquids, moisture evaporation, air quality improvement, temperature regulation, and/or enhanced environmental conditions measurements.

In some examples, device longevity can be improved using the techniques described herein. For example, the anharmonic waveform can be used for moisture management, maintaining an operating temperature and/or climate for electronic components within specification, and/or clearing dust particles to maintain efficiency. In some examples, the processor selects or generates an appropriate anharmonic waveform based on sensor feedback, facilitating real-time adaptive environmental management.

### BRIEF DESCRIPTION OF THE DRAWINGS

FIGS. 1A-1F illustrate electronic devices that may incorporate a loudspeaker system designed to induce turbulent airflow within the device, in accordance with some examples of the disclosure.

FIG. 2 illustrates a block diagram of an example electronic device, in accordance with some examples of the disclosure.

FIG. 3 illustrates a cross-sectional view of a multi-port cavity configuration of an electronic device, in accordance with some examples of the disclosure.

FIGS. 4A-4D illustrate example configurations of ports within a cavity of an electronic device, in accordance with some examples of the disclosure.

FIG. 5 illustrates a graph of an example waveform representing the drive voltage that can be applied to a loudspeaker, in accordance with some example of the disclosures.

FIG. 6 illustrates a graph that delineates the pneumatic resistances to airflow of two example ports within an electronic device's cavity, plotted against air speed, in accordance with some examples of the disclosure.

FIG. 7 illustrates a cross-sectional view of a multi-port cavity configuration of an electronic device including a sensor, in accordance with some examples of the disclosure.

FIG. 8 illustrates a flow diagram illustrating a method for moisture detection and regulation within the cavity of an electronic device, in accordance with some examples of the disclosure.

FIG. 9 illustrates a flow diagram of an example method for measuring external ambient conditions using one or more sensors within the cavity and an induced airflow, in accordance with some examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

This relates to an electronic device with an airflow management system. In some examples, the device includes a cavity with two (or more) ports with different pneumatic resistances at different wind speeds. In some examples, a loudspeaker, driven by an anharmonic function, induces turbulent airflow within the cavity. In some examples, the loudspeaker induces turbulent airflow through one port and laminar airflow through another port during a rapid movement of a diaphragm of the loudspeaker, as described in greater detail herein. In some examples, the loudspeaker induces laminar airflow through the two (or more) ports during a slow movement of the diaphragm, as described in greater detail herein. In some examples, the device utilizes the differential pneumatic resistance between the ports to generate net airflow, leveraging variations in air speed for environmental conditioning (e.g., extending functionality of the loudspeaker beyond sound production).

In some examples, the different pneumatic resistances at a relatively higher air speed can be achieved using meshed versus non-meshed ports, meshed ports with different mesh densities, different airflow paths between ports, and/or different sized ports. In some examples, one or more sensors placed within the cavity enable monitoring of one or more environmental conditions. Data from the one or more sensors may cause operational adjustments for the device, such as displacing liquids, moisture evaporation, air quality improvement, and/or temperature regulation.

In some examples, device longevity can be improved using the techniques described herein. For example, the anharmonic waveform can be used for moisture management, maintaining an operating temperature and/or climate for electronic components within specification, and/or clearing dust particles to maintain efficiency. In some examples, the processor selects or generates an appropriate anharmonic waveform based on sensor feedback, facilitating real-time adaptive environmental management.

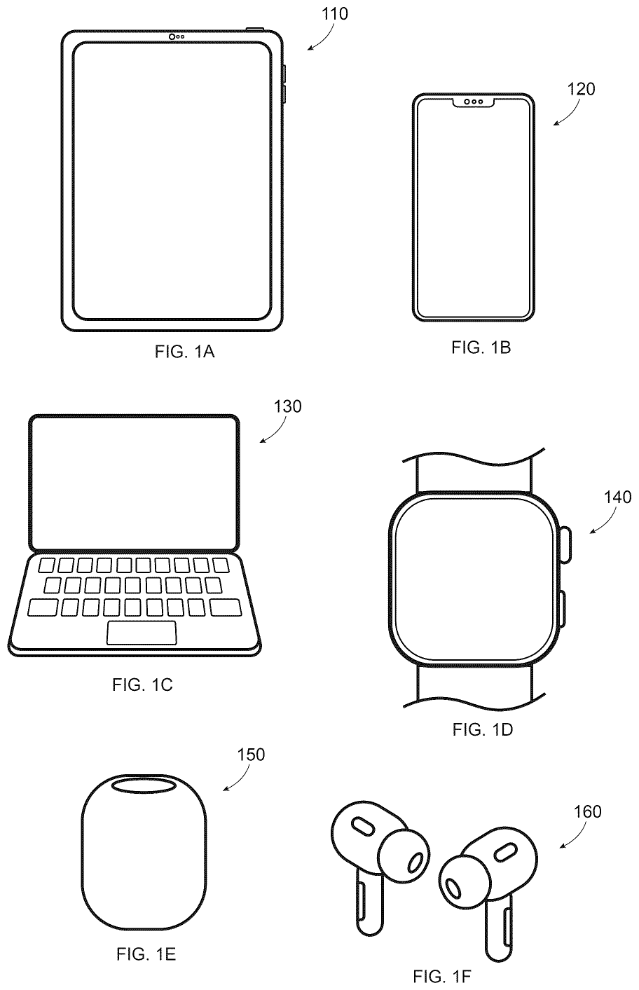

FIGS. 1A-1F illustrate examples of electronic devices that may incorporate a loudspeaker system designed to induce net airflow through the device for various applications, including but not limited to, moisture evaporation and ambient condition sensing, as described in greater detail herein. FIG. 1A illustrates an example tablet 110 that may include a loudspeaker system within a cavity, according to examples of the disclosure. FIG. 1B illustrates an example mobile telephone 120 that may include a loudspeaker system within a cavity, according to examples of the disclosure. FIG. 1C illustrates an example laptop 130 that may include a loudspeaker system within a cavity, according to examples of the disclosure. FIG. 1D illustrates an example wearable device 140 (e.g., a smartwatch) that may include a loudspeaker system within a cavity, according to examples of the disclosure. FIG. 1E illustrates an example smart home device 150 (e.g., a smart speaker) that may include a loudspeaker system within a cavity, according to examples of the disclosure. FIG. 1F illustrates example headphones 160 that may include a loudspeaker system within a cavity, according to examples of the disclosure.

It should be understood that the devices illustrated in FIGS. 1A-1F are provided by way of example, and other devices may include a loudspeaker system within a cavity, according to examples of the disclosure.

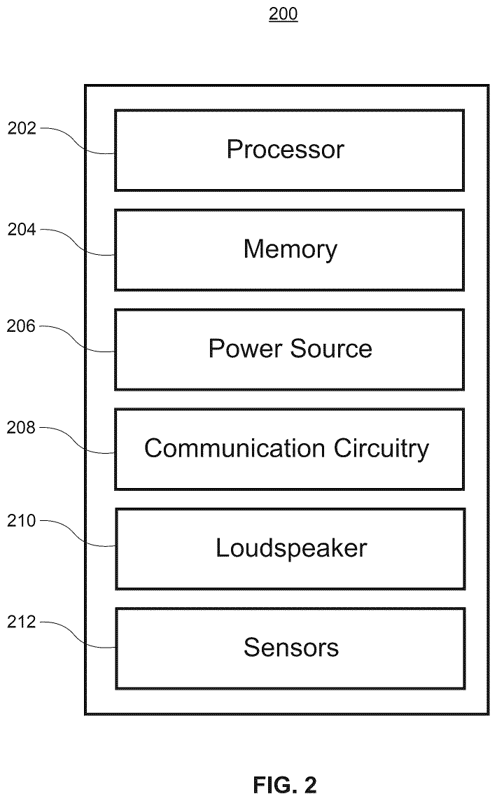

FIG. 2 illustrates a block diagram of an example electronic device 200, according to examples of the disclosure. Electronic device 200 may include a loudspeaker system within a cavity, according to examples of the disclosure. Electronic device 200 may refer to or be included in any of tablet 110, mobile telephone 120, laptop 130, wearable device 140, smart home device 150, headphones 160, or any mobile or non-mobile computing device.

FIG. 2 illustrates example components that may be included in electronic device 200. The actual physical locations of components in electronic device 200 relative to each other and to a housing of electronic device 200 may differ from the locations depicted in FIG. 2.

In some examples, electronic device 200 may include a processor 202, a memory 204, a power source 206, communication circuitry 208, a loudspeaker 210, and sensors 212. Processor 202 may control some or all the operations of electronic device 200. Processor 202 may communicate, either directly or indirectly, with some or all the other components of electronic device 200. For example, a system bus or other communication mechanism may provide communication between processor 202, memory 204, power source 206, communication circuitry 208, loudspeaker 210, and sensors 212.

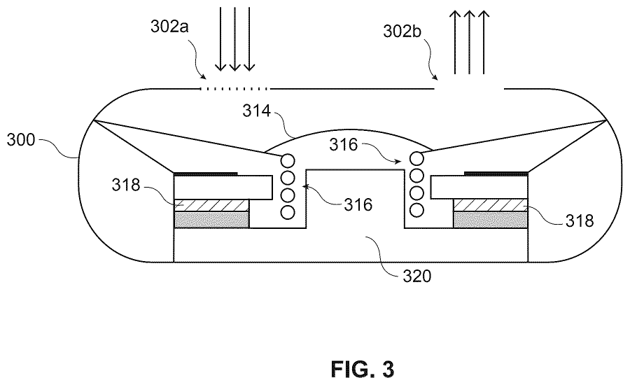

Processor 202 may be implemented as any electronic device capable of processing, receiving, or transmitting data or instructions, whether such data or instructions are in the form of software or firmware or otherwise encoded. For example, processor 202 may include a microprocessor, a central processing unit (CPU), an application-specific integrated circuit (ASIC), a digital signal processor (DSP), a controller, or a combination of such devices. As described herein, the term “processor” or “processing circuitry” is meant to encompass a single processor or processing unit, multiple processors, multiple processing units, or other suitably configured computing element or elements. In some examples, processor 202 may provide part or all the processing systems or processors described with reference to any of FIGS. 3-9.

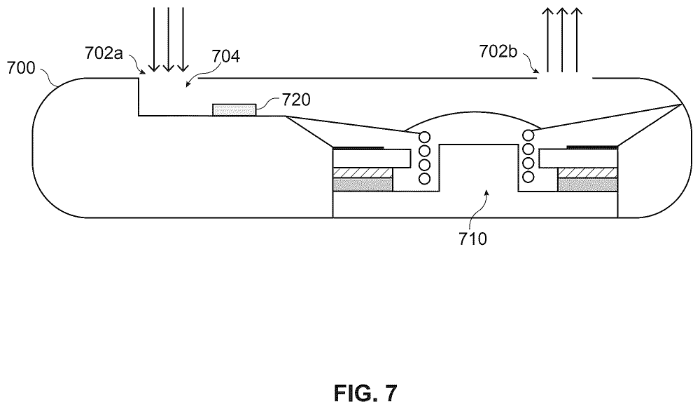

Processor 202 may be responsible for controlling the operations of both loudspeaker 210 and sensors 212 within electronic device 200. Processor 202 may send commands to loudspeaker 210, driving loudspeaker 210 with an anharmonic function designed to manipulate air movement within a cavity of electronic device 200, as described in greater detail with respect to FIGS. 3-6. Additionally, processor 202 may utilize data received from sensors 212 to inform its decisions on how to drive loudspeaker 210. For example, if sensors 212 report changes in humidity, temperature, or other relevant environmental parameters, processor 202 may dynamically adjust the output of loudspeaker 210, as described in greater detail with respect to FIG. 7.

Memory 204 may store electronic data that may be used by electronic device 200. For example, memory 204 may store electrical data or content such as, for example, audio and video files, documents and applications, firmware, device settings and user preferences, timing signals, control signals, and data structures or databases. Memory 204 may include any type of memory. By way of example only, memory 204 may include random access memory, read-only memory, Flash memory, removable memory, other types of storage elements, or combinations of such memory types. In some examples, memory 204 may store configuration data and operational algorithms for loudspeaker 210, such as settings defining the operation of the anharmonic functions, parameters for airflow induction, and profiles for different operational modes, as described in greater detail herein. In some examples, memory 204 may store calibration data for sensors 212 for ensuring accurate environmental sensing and response.

It should be noted that one or more of the functions described in this disclosure may be performed by firmware stored in memory 204 and executed by processor 202 or other processing circuitry of electronic device 200. The firmware may also be stored and/or transported within any non-transitory computer-readable storage medium for use by or in connection with an instruction execution system, apparatus, or device, such as a computer-based system, processor-containing system, or other system that may fetch the instructions from the instruction execution system, apparatus, or device and execute the instructions. As described herein, a “non-transitory computer-readable storage medium” may be any medium (excluding signals) that may contain or store the program for use by or in connection with the instruction execution system, apparatus, or device. In some examples, memory 204 may be a non-transitory computer readable storage medium. The non-transitory computer readable storage medium (or multiple thereof) may have stored therein instructions, which when executed by processor 202 or other processing circuitry, may cause the device including electronic device 200 to perform one or more functions and methods of one or more examples of this disclosure. The computer-readable storage medium may include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a compact disc (CD), CD-R, CD-RW, digital versatile disc (DVD), DVD-R, or DVD-RW, or flash memory such as compact flash cards, secured digital cards, USB memory devices, memory sticks, and the like.

The firmware may also be propagated within any transport medium for use by or in connection with an instruction execution system, apparatus, or device, such as a computer-based system, processor-containing system, or other system that can fetch the instructions from the instruction execution system, apparatus, or device and execute the instructions. As described herein, a “transport medium” may be any medium that can communicate, propagate or transport the program for use by or in connection with the instruction execution system, apparatus, or device. The transport medium may include, but is not limited to, an electronic, magnetic, optical, electromagnetic or infrared wired or wireless propagation medium.

Power source 206 may be implemented with any device capable of providing energy to electronic device 200. For example, power source 206 may include one or more batteries or rechargeable batteries. Additionally or alternatively, power source 206 may include a power connector or power cord that connects electronic device 200 to another power source, such as a wall outlet, solar cell, or wireless charging system.

Communication circuitry 208 may transmit data to or receive data from another electronic device. Communication circuitry 208 may include wireless or wired communication interfaces. In some examples, communication circuitry 208 may include one or more antennas for receiving and transmitting cellular, Bluetooth, Wi-Fi, and/or other types of wireless signals.

Loudspeaker 210 may be driven by processor 202 to generate sound waves. For example, processor 202 can provide instructions to a driver to execute anharmonic functions designed to induce turbulent airflow within a cavity of electronic device 200, as described in greater detail herein. Thus, loudspeaker 210 may contribute to various applications beyond generating audio outputs for a user of the device, including moisture evaporation, enhancing sensor accuracy, cooling, or other applications where circulating ambient air within a cavity may be advantageous. Loudspeaker 210 may include one or more of a dynamic (moving coil) loudspeaker, electrostatic loudspeaker, planar magnetic loudspeaker, ribbon loudspeaker, piezoelectric loudspeaker, balanced armature loudspeaker, flat panel loudspeaker, horn loudspeaker, transmission line loudspeaker, bass reflex loudspeaker, or any loudspeaker which may be driven in a manner to achieve the desired airflow effects described herein.

Sensors 212 may be utilized to monitor various environmental and operational parameters within and around electronic device 200. Sensors 212 may include, but are not limited to, sensors for measuring temperature, humidity, air composition, pressure, air quality, airflow, infrared light, optical light, ultraviolet light, proximity, acceleration, rotational motion, gas, particulate matter, sound, or any other sensors. Sensors may relay appropriate data to processor 202 so it may adjust the operation of loudspeaker 210 to meet a desired objective, as described in greater detail herein.

It should be apparent that the architecture shown in FIG. 2 is only one example architecture of electronic device 200 and that the device could have fewer or more components than shown, or a different configuration of components. The various components shown in FIG. 2 may be implemented in hardware, software, firmware, or any combination thereof, including one or more signal processing and/or application specific integrated circuits (ASICs).

FIG. 3 illustrates a cross-sectional view of a multi-port cavity configuration of an electronic device, including a loudspeaker 310 disposed within cavity 300. In some examples, loudspeaker 310 includes components such as a diaphragm 312, a dust cap 314, a voice coil 316, magnets 318, and a loudspeaker body 320. Although depicted with these specific parts, it should be understood that loudspeaker 310 may include more, fewer, or additional components than shown. Cavity 300, as illustrated in FIG. 3, features two ports 302 on one side. A first port is an opening equipped with a mesh (meshed port 302a) and a second port is an opening without a mesh (non-meshed port 302b). In some examples, different configurations of ports are possible, such as a different number of ports or a different disposition of the ports (e.g., ports on one or more different sides of the cavity).

Cavity 300, as illustrated in FIG. 3, defines an enclosed space designed to house loudspeaker 310 and/or facilitate airflow dynamics described herein. In some examples, loudspeaker 310 is disposed only partially within cavity 300, while in other examples, loudspeaker is not disposed within cavity 300, and cavity 300 is coupled to the output of loudspeaker 310. While cavity 300 is illustrated as a cylindrical shape with rounded edges, it should be understood that cavity 300 may adopt any shape (e.g., rectangular, elliptical, or non-regular geometric configurations) which allows for housing loudspeaker 310 and ensuring that sound waves generated by loudspeaker 310 resonate and contribute to air movement. The dimensions of cavity 300 may vary based on the type and size of the electronic device in which it is incorporated. For small devices like tablet 110, mobile telephone 120, wearable device 140, or headphones 160, cavity 300 may have dimensions such as a length of 5 mm, 10 mm, 15 mm, 25 mm, or 50 mm; a width of 3 mm, 6 mm, 10 mm, 15 mm, 25 mm, or 40 mm; and a depth (not shown) of 3 mm, 5 mm, 8 mm, 10 mm, 15 mm, or 20 mm. In larger devices such as laptop 130 or smart home device 150, cavity 300 may be larger as well, with dimensions such as a length of 50 mm, 75 mm, 100 mm, 150 mm, or 250 mm; a width of 10 mm, 20 mm, 40 mm, 80 mm, 120 mm, or 200 mm; and a depth (not shown) of 10 mm, 20 mm, 40 mm, 80 mm, 120 mm, or 200 mm. It should be understood that the dimensions above are examples, and the actual dimensions may be different depending on the size of the speaker, the size of the electronic device, etc.

In some examples, two or more ports may be incorporated into cavity 300 to enable air ingress and egress. Specifically, as illustrated in FIG. 3, cavity 300 may include meshed port 302a and non-meshed port 302b, but any configuration of ports which allows for a current of air to flow through cavity 300 may be employed. In some examples, meshed port 302a may include a mesh covering to introduce pneumatic resistance to air passage that is different than the pneumatic resistance of non-meshed port 302b at different air velocities. Within the context of this disclosure, pneumatic resistance refers to the resistance against the movement of air through a specific pathway, such as a port, cavity, or duct. The pneumatic resistance is a measure of how much a device or component obstructs the flow of air, determined by various factors including the geometry of the air path, surface texture, presence of obstacles (e.g., meshes or filters), and the air's velocity and density. A higher pneumatic resistance indicates greater resistance to airflow, which may be used to create a difference in airflow between two ports at different air velocities, as described in greater detail below.

The mesh of meshed port 302a may be made from various materials, including but not limited to, metal wire, synthetic fibers, or fine textile materials. The structural characteristics of the mesh may be selected based on the desired airflow characteristics. In particular, the weave density or hole size of the mesh may influence the amount of air that may pass: a greater density or smaller hole size may correspond to a greater pneumatic resistance due to more turbulent airflow at relatively higher air speeds, while a lower density or larger hole size may correspond to a lower pneumatic resistance due to laminar flow characteristics. In some examples, non-meshed port 302b does not include a mesh, thus providing a more laminar path for air. The absence of a mesh in non-meshed port 302b may serve to establish a differential pneumatic resistance at relatively higher air speeds between it and meshed port 302a, which facilitates the flow of air within cavity 300, as described in greater detail with respect to FIG. 6. In some examples, ports 302 may induce a laminar flow of air at relatively low airflow velocities and a turbulent flow of air at relatively high airflow velocities, as described in greater detail with respect to FIG. 6. The dimensions of ports 302 may vary depending on the electronic device's specific design and operational requirements. For example, the area of ports 302 may be 0.25 mm², 0.5 mm², 1 mm², 4 mm², 25 mm², 100 mm², 225 mm², 625 mm², or 2500 mm². While ports 302 are illustrated as having the same dimensions, it should be understood that various port configurations are possible and ports 302 may have the same or different dimensions. In some examples, ports 302 may take various shapes, including circular, rectangular, square, oval, triangular, or other geometries tailored to specific design preferences or operational goals. For example, the shape of ports 302 may influence airflow dynamics, where certain shapes may promote laminar flow at lower velocities and facilitate the transition to turbulent flow at relatively higher velocities. In some examples, ports 302 may differ in shape from one another, allowing for further customization of airflow characteristics within cavity 300 to achieve the environmental conditions described herein.

In some examples, loudspeaker 310 is or includes an electromechanical device that converts electrical signals into audible sound waves. In other examples, loudspeaker 310 is or includes any transducer capable of inducing airflow within cavity 300. In some examples, loudspeaker 310 includes a diaphragm 312, which is a movable element that vibrates to create sound waves. Diaphragm 312 may be made from materials such as paper, plastic, or metal. Loudspeaker 310 may also include a dust cap 314, disposed at the center of diaphragm 312, which may protect components of loudspeaker 310, such as voice coil 316, from dust and debris, while also contributing to the overall structural integrity of diaphragm 312. Dust cap 314 may be made from the same material as diaphragm 312, but may also be made from any materials such as paper, plastic, or metal. In some examples, voice coil 316 may be a coil of wire disposed in the magnetic gap of the loudspeaker, illustrated in FIG. 3 as the space between loudspeaker body 320 and magnets 318. In some examples, when an electrical current passes through voice coil 316, voice coil 316 generates a magnetic field that interacts with magnets 318, causing voice coil 316 and diaphragm 312, which may be attached to voice coil 316, to move together. The movement of voice coil 316 directly translates into the vibration of diaphragm 312, producing sound waves and causing airflow. Voice coil 316 may be made of a highly conductive metal, such as copper or aluminum. In some examples, magnets 318 may create a permanent magnetic field in which voice coil 316 operates, as described above. In some examples, magnets 318 may be ferrite, neodymium, or alnico magnets. In some examples, loudspeaker body 320 may hold all the loudspeaker components described above together and may provide a mounting structure that may be secured within cavity 300. In some examples, loudspeaker body 320 is made from metal or rigid plastic.

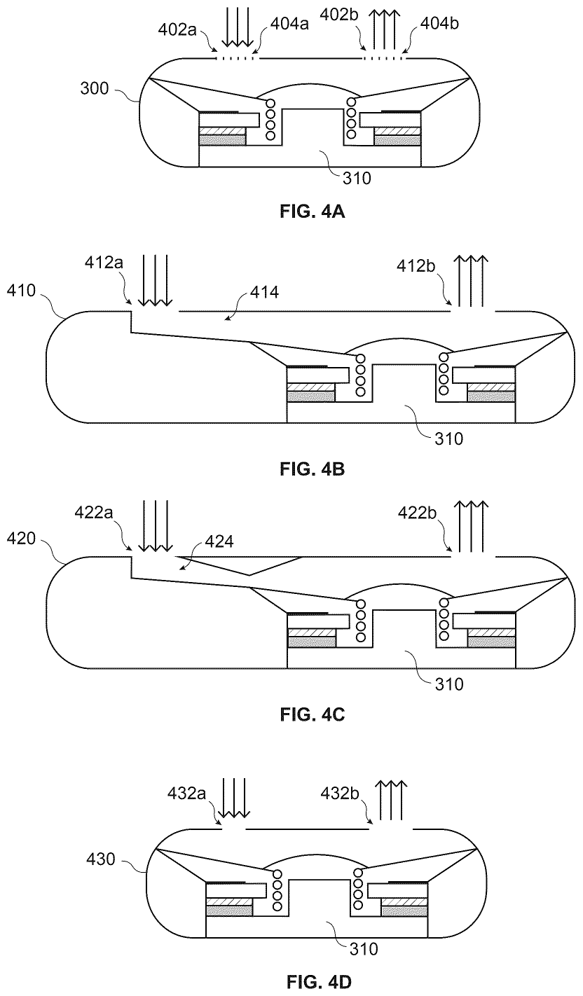

FIGS. 4A-4D illustrate example configurations of ports within a cavity of an electronic device, each illustrating a different approach to establishing differential pneumatic resistance to facilitate controlled airflow dynamics than the approach shown in FIG. 3.

FIG. 4A illustrates an example port configuration within cavity 400, featuring two meshed ports 402a and 402b disposed on one side. In this example, meshed ports 402a and 402b are equipped with meshes 404a and 404b, respectively, and share identical shape and dimensions. However, in some examples, the shape and dimensions of ports 402a and 402b may be different from each other. Mesh 404a and mesh 404b have differently changing pneumatic resistances with changing air speeds. For example, mesh 404a has a higher density than mesh 404b and, consequently, stronger turbulent flow characteristics at higher wind speeds, resulting in a lower permeability than mesh 404b. The lower permeability of mesh 404a at higher wind speeds means that air passes through it with more difficulty compared to the air passing through mesh 404b. This difference in permeability between meshes 404a and 404b results in a differential pneumatic resistance of ports 402a and 402b.

FIG. 4B illustrates an example port configuration within cavity 410, featuring two non-meshed ports 412a and 412b disposed on one side. However, the pathways between the loudspeaker 310 and the ports 412a and 412b are different and thereby have different pneumatic resistances at different air speeds. While in this example ports 412a and 412b share identical shape and dimensions, it should be understood that the shape and dimensions of ports 412a and 412b may be different from each other. In this example, port 412b is connected to loudspeaker 310, providing a relatively straightforward path for airflow with less resistance compared with port 412a. On the other hand, port 412a is connected to a tube 414 that extends the pathway air travels before reaching loudspeaker 310. In this example, the inclusion of tube 414 in the pathway of port 412a increases the pneumatic resistance due to the extended length of the air's travel path. This longer path requires air to overcome more resistance before exiting or entering cavity 410, compared to the path provided by port 412b. Tube 414 may be a conduit adopting various configurations, including cylindrical, rectangular, helical, conical, or spiral shapes, among other possibilities including non-regular geometries. Tube 414 not only increases the distance, but it also presents a more restrictive cross-sectional area that limits airflow and may also introduce additional frictional forces against the airflow, such as surface roughness, air viscosity, and obstacles, further contributing to the increased pneumatic resistance. In some examples, the internal surface roughness of tube 414 may be increased to further increase the pneumatic resistance by incorporating micro-grooved walls, applying textured coatings, embedding particulate matter, utilizing porous materials, or adding internal fins or ridges. Therefore, the port configuration provided in this example also establishes a differential pneumatic resistance at different air speeds between ports 412a and 412b, as port 412b exhibits a relatively lower pneumatic resistance at a higher air speed due to laminar flow characteristics, while port 412a exhibits a relatively higher pneumatic resistance at a higher air speed due to turbulent flow characteristics.

FIG. 4C illustrates an example port configuration with two non-meshed ports 422a and 422b disposed on one side of cavity 420. This example is similar to the example of FIG. 4B, with port 422b connected to loudspeaker 310 (similar to port 412b), but with port 422a being connected to a tapered tube 424, which narrows towards loudspeaker 310. While in this example ports 422a and 422b share identical shape and dimensions, it should be understood that the shape and dimensions of ports 422a and 422b may be different from each other. In this example, the pneumatic resistance is increased in port 422a for similar reasons as those described with respect to port 412a. Additionally, the tapered design of tapered tube 424 increases pneumatic resistance by gradually reducing the cross-sectional area available for airflow as it approaches loudspeaker 310. This constriction accelerates air velocity according to the Venturi effect, which states that fluid flow speed increases as it passes through a narrowed section of a tube. The increase in airflow velocity within the tapered section may induce turbulence, especially as air particles interact more aggressively with the narrowing walls of tapered tube 424, compared to a straight tube, such as tube 414. Therefore, the port configuration provided in this example also establishes a differential pneumatic resistance at different air speeds between ports 422a and 422b, as port 422b exhibits a relatively lower pneumatic resistance at a higher air speed due to laminar flow characteristics, while port 422a exhibits a relatively higher pneumatic resistance at a higher air speed due to turbulent flow characteristics.

FIG. 4D illustrates an example port configuration where two non-meshed ports 432a and 432b are disposed on one side of cavity 430. Unlike the previous example configurations of FIGS. 4A-4C which utilized mesh densities and tube designs to create differential pneumatic resistance at different air speeds, this example achieves the differentiation through varying the sizes of the ports. In this example, port 432b is significantly larger than port 432a, affecting the volume of air that may pass through each port within a given timeframe. The larger cross-sectional area of port 432b allows for a greater volume of air to enter or exit cavity 430 with less resistance, resulting in a lower pneumatic resistance for port 432b compared to port 432a at a higher air speed. On the other hand, the smaller size of port 432a restricts the volume of air that may pass, creating a relatively higher pneumatic resistance at a higher air speed due to the reduced pathway available for airflow compared to port 432b. Therefore, the port configuration provided in this example also establishes a differential pneumatic resistance at different air speeds between ports 432a and 432b, as port 432b exhibits a relatively lower pneumatic resistance at a higher air speed due to laminar flow characteristics, while port 432a exhibits a relatively higher pneumatic resistance at a higher air speed due to turbulent flow characteristics. While the various examples described in FIGS. 3 and 4A-4D have been presented separately for clarity, it should be understood that features from one or more of these examples may be combined or blended to achieve different pneumatic resistances between the ports. For example, to achieve a differential pneumatic resistance, a combination of port geometry and mesh sizing may be employed, such as using smaller port dimensions (as in FIG. 4D) in conjunction with different mesh permeabilities (as in FIG. 4A).

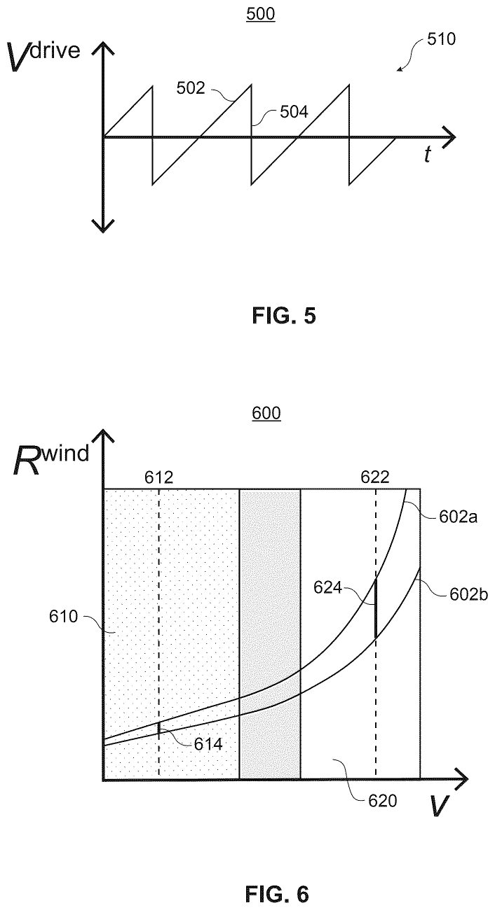

As described herein, driving loudspeaker 310 can facilitate airflow dynamics. For example, a drive instruction and/or waveform can be provided from processor 202, memory 204, and/or a loudspeaker driver. FIG. 5 illustrates a graph 500 of an example waveform, an anharmonic sawtooth waveform 510, representing the drive voltage (V^{drive}) that can be applied to the loudspeaker. The example waveform is plotted with time on the x-axis and V^{drive} on the y-axis. Taking the device of FIG. 3 as an example, this specific waveform allows for the creation of a net airflow through cavity 300 by controlling the movement of diaphragm 312 of loudspeaker 310.

Driving loudspeaker 310 with a voltage following a harmonic function (e.g., a sine wave), induces symmetric oscillations in diaphragm 312, which pushes and pulls air in equal amounts through cavity 300. This symmetric motion results in no net airflow through cavity 300, as the air displaced in one direction is precisely counterbalanced by air moving in the opposite direction.

This equilibrium may be disrupted by driving loudspeaker 310 with an anharmonic function, such as sawtooth waveform 510. Sawtooth waveform 510 includes a gradual transition 502 from Vmin to Vmax and a rapid transition 504 from Vmax to Vmin. This waveform induces a non-uniform movement pattern in diaphragm 312—retracting slowly to facilitate laminar flow through ports 302a and 302b at reduced air speeds, then extending rapidly, to provide air speeds faster than a critical velocity to induce turbulent flow in at least one of ports 302. In some examples, the rapid expansion can potentially reach speeds up to 60 m/s (e.g., a speed achievable by consumer loudspeakers). In scenarios where the airflow remains within the laminar regime even during the faster air speeds, the pneumatic resistance ratio between both ports 302a and 302b remains relatively constant, which, similar to when loudspeaker 310 is driven by a harmonic function, would preclude net airflow in cavity 300, as described in greater detail with respect to FIG. 6. However, if the rapid extension of diaphragm 312 generates air speeds sufficient to transition into turbulent flow (e.g., air speeds faster than a critical velocity), the pneumatic resistance ratio between ports 302a and 302b diverges significantly (e.g., by more than a threshold) from the pneumatic resistance ratio between ports 302a and 302b during laminar flow, as described in greater detail with respect to FIG. 6. The variation in the pneumatic resistance ratios between ports 302a and 302b during laminar flow and turbulent flow enables a net airflow through cavity 300 by disrupting the balance of air movement, resulting in more air being expelled through one port than is drawn in through the other, as described in greater detail with respect to FIG. 6.

In some examples, sawtooth waveform 510 may be operated at frequencies either below 20 Hz or above 20,000 Hz to ensure that the induced airflow does not interfere with audible sound production or add acoustic noise to the device's environment. While a sawtooth waveform is illustrated in FIG. 5, it should be understood that alternative waveforms capable of instigating abrupt air pressure and velocity shifts—such as square waves, pulse waves, triangular waves, or complex periodic waves—may also facilitate net airflow through cavity 300.

In some examples, the anharmonic function driving the loudspeaker is configured as a harmonic stack, including multiple harmonic waveforms layered together. Phases of one or more waveforms within this harmonic stack may be synchronized such that their ascending segments occur concurrently, thereby generating a rapid increase in air pressure and velocity to induce turbulent airflow through cavity 300. In some examples, the alignment of the waveforms within the harmonic stack may be further refined to create diffuse descending segments. This alignment aims to induce a mitigated laminar airflow in both ports 302a and 302b, which generates the necessary variation in the pneumatic resistance ratios between ports 302a and 302b during turbulent and laminar flow. The waveform realignment within the harmonic stack may allow the electronic device to utilize the natural audio output of loudspeaker 310 to induce the desired airflow dynamics without perceptible alteration to the listener. This technique exploits the human auditory system's insensitivity to minor phase shifts, allowing for audio fidelity preservation while managing the airflow within cavity 300, thereby obviating the need for a separate drive signal dedicated solely to airflow manipulation, which may conserve power and/or computational resources.

FIG. 6 illustrates a graph 600 that delineates the pneumatic resistances to airflow of two example ports within an electronic device's cavity, plotted against air speed. For ease of discussion, in this example, pneumatic resistances 602a and 602b may correspond to ports 302a and 302b of FIG. 3, respectively.

Initially, at lower air speeds corresponding to a laminar flow region 610, graph 600 illustrates that while pneumatic resistance 602a consistently exceeds pneumatic resistance 602b, the disparity between them remains relatively constant. Thus, the ratio between pneumatic resistance 602a and pneumatic resistance 602b also remains relatively constant in laminar flow region 610. As discussed above with reference to FIG. 5, if the movement of diaphragm 312 only produces air speeds within laminar flow region 610, the relatively small difference in the pneumatic resistance ratios induces little to no net airflow through cavity 300 (e.g., less than a threshold net airflow).

However, at higher air speeds corresponding to a turbulent flow region 620, graph 600 illustrates a marked transformation in the relationship between pneumatic resistance 602a and 602b. Within turbulent flow region 620, the ratio between pneumatic resistances 602a and 602b begins to expand (e.g., exponentially). The increase in the ratio is a direct consequence of the turbulent flow's chaotic and random nature, which intensifies the pneumatic resistance disparity between ports 302a and 302b far more than what is observed in laminar flow region 610. For example, at a laminar air speed 612, the difference between pneumatic resistances 602a and 602b, represented by ΔR^{wind} 614, is relatively smaller, whereas at a turbulent air speed 622, the difference between pneumatic resistances 602a and 602b, represented by ΔR^{wind} 624, is relatively larger. Therefore, an anharmonic drive such as the non-symmetrical sawtooth waveform described in FIG. 5 may specifically leverage this phenomenon by manipulating air speeds to transition between laminar and turbulent flows strategically. This air speed manipulation allows for exploiting the different pneumatic resistances at different air speeds of ports 302a and 302b to foster conditions conducive to generating a directional airflow within cavity 300 without the need for additional mechanical components such as valves or fans. In some examples, ΔR^{wind} 624 is smaller than a turbulence pneumatic resistance threshold during laminar airflow and ΔR^{wind} 624 is larger than the turbulence pneumatic resistance threshold during turbulent airflow. In some examples, the turbulence pneumatic resistance threshold refers to a minimum value of ΔR^{wind} that ensures a directed airflow within the cavity, significantly distinguishing turbulent flow conditions from the lower ΔR^{wind} observed during laminar flow. In some examples, the turbulence pneumatic resistance threshold is established based on the ΔR^{wind} observed during laminar flow. This approach may ensure that the minimum ΔR^{wind} required for ensuring the directed airflow is higher (e.g., a threshold amount such as 1%, 5%, 10%, 20%, 50%, 100%, etc.) than any ΔR^{wind} measured during laminar flow. By defining the turbulence pneumatic resistance threshold in this manner, the device can precisely control the airflow dynamics within the cavity to achieve directed airflow when needed, thereby facilitating the desired environmental adjustments within the device without manual adjustments or additional electro-mechanical systems.

To estimate whether laminar or turbulent dynamics govern the flow of liquids or gases, typically the Reynolds number is evaluated. The Reynolds number Re is given by:

$$Re = \frac{ρ vL}{μ}$$

where ρ is the fluid density, v is the flow speed, L is a characteristic linear dimension (such as a tube/port diameter), and μ is the dynamic viscosity of the fluid. For air, we have μ=1.83×10⁻⁵ Pa·s, and ρ=1.25 kg/m³. Considering a tube diameter of L=1 mm and air speeds of 6 m/s and 60 m/s during retraction and expansion of the loudspeaker membrane, we find Reynolds numbers of 409.8 and 4098, respectively. The transition from laminar flow to turbulent flow often occurs within the range of 2300<Re<3500. Therefore, because turbulent flow is expected for Re>3500, the examples set forth in this disclosure are able to achieve the required conditions for generating a net airflow in a cavity.

In some examples, the induced airflow described herein can be implemented in conjunction with a sensor. FIG. 7 illustrates a cross-sectional view of a multi-port cavity configuration of an electronic device similar to those illustrated in FIGS. 3 and 4A-4D, with the addition of a sensor 720 disposed within the cavity (e.g., within tube 704). In some examples, sensor 720 is disposed within the air pathway of tube 704 in order to leverage the anharmonically induced airflow to collect data on the air moving through cavity 300 (e.g., to provide to processor 202 of FIG. 2). This configuration allows for the monitoring of airflow characteristics, such as speed, volume, flow rate, and composition of the air while passing through tube 704. In some examples, sensor 720 represents multiple sensors (or a sensor module including multiple sensors) disposed within cavity 700, each capable of measuring different environmental characteristics. For example, a first sensor could measure airflow rate, a second sensor could measure temperature, and a third sensor could measure humidity levels. In some examples, sensor 720 may measure environmental conditions external to the electronic device by analyzing the characteristics of air entering cavity 700, such as its temperature, humidity, particulate composition, carbon dioxide level, oxygen level, noxious gas level (e.g., toxic gases and vapors such as carbon monoxide or asphyxiates), pollen count, or smoke density. In some examples, processor 202 may alert a user of the electronic device when one or more characteristics of the air entering cavity 700 require their attention (e.g., dangerous conditions when the temperature is above a threshold (e.g., 40° C., 42.5° C., 45° C., etc.) or noxious gases are detected, or health concerns when pollen count and/or smoke density are above a threshold). In some examples, sensor 720 may measure environmental conditions internal to the electronic device (e.g., within cavity 700) by analyzing the characteristics of air exiting cavity 700, such as moisture content or relative humidity, temperature, airflow rate, or particulate composition. In some examples, sensor 720 may measure various environmental conditions within cavity 700 to ensure environmental conditions are maintained within specified ranges or thresholds. For instance, sensor 720 may monitor changes in moisture levels to prevent humidity exceeding a specific percentage (e.g., 60% relative humidity) that could damage electronic components, assess airflow characteristics to ensure moisture is evaporated efficiently within predefined timeframes (e.g., a rate of at least 1 g/m²/hour or 1 mm/hour), track temperature to keep electronic components operating within a safe temperature range (e.g., 0° C. to 40° C.), evaluate particulate matter composition to keep it below a level that could impair device function (e.g., 50 μg/m3), or monitor for any other environmental condition relevant to maintaining the device's internal environment. It should be noted that the placement of sensor 720 may be varied within different parts of cavity 700 or tube 704 to target specific airflow characteristics or operational objectives. For example, sensor 720 may be disposed in the space surrounding loudspeaker 710 to assess the moisture content in the air directly surrounding loudspeaker 710.

In some examples, sensor 720 detects moisture within cavity 700 and relays this data to processor 202. When processor 202 determines that the moisture within cavity 700 exceeds a predefined threshold, processor 202 may initiate a process to drive loudspeaker 710 with a voltage following an anharmonic function, as described in FIGS. 5 and 6. Loudspeaker 710 then induces a mix of laminar and turbulent airflow through ports 702a and 702b to create a directional airflow which expels air through port 702b and draws in air through port 702a. This directional airflow facilitates the replacement of saturated air near wet surfaces with drier air from outside cavity 700, increasing the rate of evaporation within cavity 700. In addition, the rapid movement of the diaphragm of loudspeaker 710, particularly during the anharmonic wave's rapid outward movement, may create high-velocity air currents that disrupt the boundary layer of air adjacent to any wet surfaces within cavity 700. This disruption reduces the thickness of the boundary layer, allowing more moisture to escape into the air flow and be expelled from cavity 700 through ports 702a and 702b. In some examples, loudspeaker 710 may be configured to expel water droplets from cavity 700 through rapid, targeted movements of its diaphragm.

In some examples, depending on the amount of moisture detected within cavity 700, processor 202 may select or generate an appropriate anharmonic waveform to optimize evaporation efficiency. For instance, in a case where a relatively large amount of moisture is detected in cavity 700, processor 202 may drive loudspeaker 710 with an anharmonic wave that produces stronger air currents within cavity 700 to eliminate moisture faster. Conversely, in a case where a relatively small amount of moisture is detected in cavity 700, processor 202 may drive loudspeaker 710 with an anharmonic wave that produces weaker air currents within cavity 700 to conserve more energy. In some examples, processor 202 may generate an appropriate anharmonic waveform by modifying its characteristics, such as its frequency, amplitude, waveform shape, phase shift, or duty cycle.

In some examples, sensor 720 may measure characteristics of the airflow through cavity 700 to ensure an intended objective (e.g., measuring external environmental conditions or increasing the evaporation rate) of the electronic device is being met. For example, sensor 720 may send continuous feedback on one or more characteristics of the airflow to processor 202, which in turn evaluates the performance of the airflow against the intended objective(s). When processor 202 identifies a discrepancy between the current airflow effectiveness and the intended objective, it may dynamically adjust the anharmonic waveform driving loudspeaker 710 to optimize airflow characteristics. Dynamically adjusting the anharmonic waveform may involve altering the frequency, amplitude, waveform shape, phase shift, duty cycle, or other characteristics of the anharmonic function to increase airflow, direct airflow more effectively, or adapt to changing environmental conditions inside or outside the cavity. For instance, if increased evaporation is needed but the airflow is not removing moisture efficiently, processor 202 may adjust the anharmonic waveform to induce stronger turbulent flows, thereby enhancing the evaporation rate. As another example, if the intended objective is to more accurately measure external environmental conditions, but the air within cavity 700 is not being replaced by external air, the measurements made by sensor 720 may not reflect accurate external environmental conditions. In this example, processor 202 may adjust the anharmonic waveform to induce a stronger air current within cavity 700 to ensure external air is being measured by sensor 720.

In some examples, processor 202, in communication with sensor 720, is able to adapt operational strategies dynamically, based on specific application requirements or internal objectives, by adjusting the anharmonic function driving loudspeaker 710. As described above, sensor 720 may detect a range of environmental conditions, from moisture levels to particulate presence, and relay this information to processor 202, which may then determine an operational mode for the device. For instance, if an objective is to enhance evaporation within cavity 700 due to detected moisture, processor 202 may enable an enhanced evaporation operational mode that includes initiating an anharmonic function optimized for evaporation. Similarly, if the goal is to measure external ambient environmental conditions accurately, processor 202 may enable an external air measurement operation mode that facilitates an airflow conducive to precise sensor readings.

Additionally, processor 202 may shift operational modes automatically in response to detected changes in internal environmental conditions, such as rising humidity levels or the presence of dust particles. This ensures objectives such as cooling electronic systems, regulating internal humidity, or expelling dust particles are met efficiently. Sensor 720 may continually measure the airflow within cavity 700 to enable processor 202 to adjust the characteristics of the anharmonic function, like frequency or amplitude, based on target metrics to maintain airflow characteristics suited to the device's intended application. Some examples of said metrics include, but are not limited to, a predetermined range of acceptable humidity levels (e.g., 30% to 50% relative humidity), specific particle density thresholds for dust (e.g., less than 0.002 grams per cubic meter), or a target temperature range (e.g., 20° C. to 25° C.). The decision-making process may involve determining benchmarks for airflow effectiveness tailored to objectives corresponding to the device's intended application, whether the objectives include maintaining sensor accuracy within a specific margin of error for environmental monitoring, achieving evaporation rates to dry internal components, or regulating the internal climate of the electronic device within specific temperature and humidity ranges to ensure performance and longevity. The intelligent adjustment capability of processor 202 from among different operational modes based on these criteria ensures the electronic device operates efficiently under varying environmental conditions, fulfilling the operational goals of the electronic device without manual intervention.

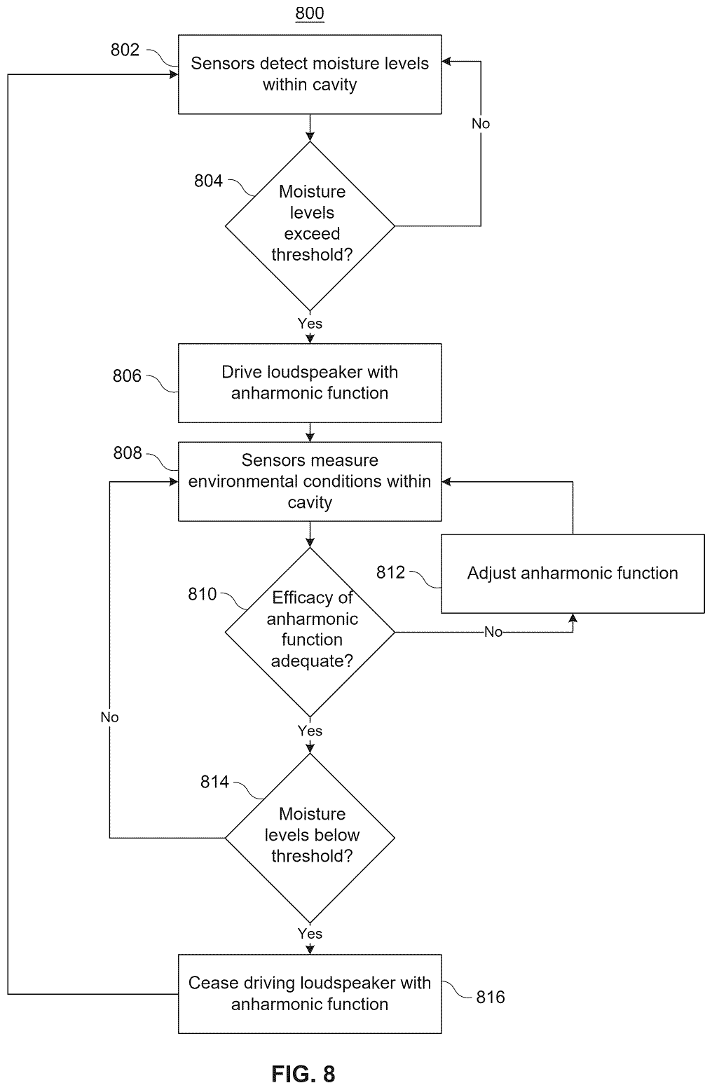

FIG. 8 illustrates a flow diagram of an example method 800 for moisture detection and regulation within the cavity of an electronic device. It should be understood that while method 800 is described below with reference to components and configurations from FIG. 7, various other components, configurations, and electronic devices may employ method 800 to achieve similar objectives. It is understood that while the objective of method 800 is described primarily in the context of moisture detection and regulation, similar methodologies using an anharmonic function and/or regulating an anharmonic function may be applied to measure within the cavity and/or manage other environmental conditions, such as temperature, air quality, and particulate matter levels, as described herein.

In some examples, at operation 802, one or more sensors detect the moisture levels within a cavity of an electronic device and relay the collected data to a processor. For example, sensor 720 may detect the moisture levels within cavity 700 of the electronic device illustrated in FIG. 7 and relay the collected data to processor 202.

In some examples, at operation 804, the processor evaluates whether the moisture levels detected by the one or more sensors exceed a moisture threshold (e.g., 80% relative humidity). For example, processor 202 may evaluate whether the moisture levels detected by sensor 720 exceed a threshold defining a maximum allowable moisture level within cavity 700.

In some examples, when the processor determines that the moisture levels within the cavity exceed the moisture threshold, method 800 proceeds to operation 806, where the processor initiates a process to drive a loudspeaker disposed within the cavity with an anharmonic function. For example, if processor 202 determines that the moisture levels within cavity 700 exceed the threshold defining the maximum allowable moisture level within cavity 700, processor 202 may initiate a process to drive loudspeaker 710 with an anharmonic function, such as sawtooth waveform 510 of FIG. 5. In some examples, the processor may tailor the anharmonic function based on the data collected by the one or more sensors. For instance, the processor may generate the anharmonic function by determining one or more characteristics of the anharmonic function (e.g., frequency, amplitude, waveform shape, phase shift, or duty cycle) to optimize the rate of moisture evaporation or expulsion based on the environmental conditions within the cavity. As another example, the processor may select the anharmonic function from one or more anharmonic functions that have been predefined for specific operational modes or conditions of the electronic device.

In some examples, when the processor determines that the moisture levels within the cavity are below or equal to the moisture threshold, method 800 does not proceed to operation 806 and instead returns to operation 802. For example, if processor 202 determines that the moisture levels within cavity 700 are below or equal to the threshold defining the maximum allowable moisture level within cavity 700, processor 202 may forgo initiating the process to drive loudspeaker 710 with the anharmonic function and instead may continue monitoring the data collected by sensor 720.

In some examples, following the initiation of the anharmonic drive of the loudspeaker, at operation 808, the one or more sensors within the cavity measure one or more environmental conditions within the cavity to ensure environmental management meets predefined criteria or to improve environmental management, as described in greater detail with respect to FIG. 7. For example, following the initiation of the anharmonic drive of loudspeaker 710, sensor 720 may assess one or more environmental conditions within cavity 700. In some examples, the one or more environmental conditions within the cavity may include one or more of changes in moisture levels, airflow characteristics (e.g., speed, volume, and direction), temperature fluctuations, particulate matter composition, or any other environmental condition that could influence the device's environmental management strategies.

In some examples, at operation 810, the processor evaluates the data collected by the one or more sensors to determine an efficacy of the current anharmonic function in modifying the one or more environmental conditions within the cavity. For example, processor 202 may evaluate the data collected by sensor 720 to determine whether the anharmonic function driving loudspeaker 710 is adequately addressing the moisture levels within cavity 700. In some examples, the processor may compare the data collected by the one or more sensors corresponding to the one or more environmental conditions against predefined benchmarks for each environmental condition to determine the efficacy of the current anharmonic function. In some examples, the predefined benchmarks against which the processor evaluates sensor data may vary depending on the specific operational mode of the device. For instance, benchmarks for moisture level reduction might be stricter in a mode prioritizing rapid water expulsion compared to a general air circulation mode. These benchmarks may be dynamically adjusted by the processor based on a variety of factors, including the ambient environmental conditions detected by the one or more sensors, the historical performance data of the device under similar environmental conditions, and the current operational state of the device (e.g., battery level or thermal status). The processor may employ algorithms to analyze trends in the data, such as the rate of change in moisture levels or airflow characteristics, to ascertain whether these trends align with expected outcomes based on the applied anharmonic function. This analysis may allow the processor to quantitatively assess whether the induced airflow is sufficiently removing moisture, circulating air according to design specifications, and achieving the set objectives for environmental control within the cavity.

In some examples, when the processor determines that the efficacy of the current anharmonic function is below an efficacy threshold, method 800 proceeds to operation 812, where the processor adjusts the anharmonic function based on the measured one or more environmental conditions and the efficacy of the anharmonic function to drive the loudspeaker. For example, when processor 202 determines that the anharmonic function driving loudspeaker 710 is not adequately addressing the moisture levels within cavity 700, processor 202 may adjust one or more characteristics of the anharmonic function (e.g., frequency, amplitude, waveform shape, phase shift, or duty cycle) to enhance the evaporation within cavity 700. In some examples, the processor may adjust the anharmonic function by selecting a different predefined anharmonic function or generating a new anharmonic function to drive the loudspeaker. This selection or generation process may take into account the specific environmental conditions that were not adequately addressed by the previous anharmonic function (e.g., to optimize airflow characteristics or moisture expulsion rates). In some examples, the processor may alter one or more characteristics of the anharmonic function, such as adjusting its frequency, amplitude, waveform shape, phase shift, or duty cycle.

In some examples, the efficacy threshold for moisture reduction is predefined or calculated based on a target rate of moisture reduction within the cavity. For instance, the processor may set a threshold that requires a threshold reduction in humidity level per unit time (e.g., 10% reduction in humidity levels every 10 minutes). When the data shows that the current anharmonic function achieves less than this target, the processor may determine that a new or adjusted anharmonic function is needed. In some examples, the efficacy threshold for airflow efficiency is predefined or calculated based on achieving a minimum level of airflow efficiency, which may be measured in terms of air volume circulated through the cavity, a tube, or a port within a given time period. For instance, the airflow efficiency may be measured in terms of cubic meters of air per minute. When the processor determines that the volume of air circulated by the current anharmonic function falls below a predefined volume threshold necessary for effective moisture removal or temperature control, the processor may determine that a new or adjusted anharmonic function is needed. In some examples, the efficacy threshold for ambient environmental condition stability is predefined or calculated based on the stability of ambient environmental conditions within the cavity, such as maintaining a consistent temperature, humidity level, or particulate matter composition. When fluctuations beyond a certain percentage are detected by the one or more sensors (e.g., temperature variations greater than 2 degrees Celsius within a 30-minute period, a humidity level change of more than 5% within a 15-minute span, or particulate matter composition increasing by over 10% within a 20-minute interval), the processor may determine that the current anharmonic function does not effectively stabilize the internal environment, prompting the selection or generation of a new or adjusted anharmonic function. In some examples, the efficacy threshold for specific airflow patterns is predefined or calculated based on a desired airflow pattern within the cavity to ensure even distribution of air or to target specific areas within the cavity for moisture removal or temperature regulation. For instance, the specific airflow pattern threshold may involve a computational fluid dynamics simulation model that predicts optimal airflow patterns. When sensor data indicate that the current anharmonic function produces airflow patterns significantly deviating from these simulations, the processor may determine that a new or adjusted anharmonic function is needed.

In some examples, after initiating the drive with the new or modified anharmonic function, method 800 may return to operation 808, where the one or more sensors continue to measure the one or more environmental conditions within the cavity to assess the effectiveness of the adjustments made to the anharmonic function. For example, after initiating the drive of loudspeaker 710 with the new or modified anharmonic function, sensor 720 may continue to measure the one or more environmental conditions within cavity 700 to assess the effectiveness of the adjustments made to the anharmonic function by processor 202.

In some examples, when the processor determines that the efficacy of the current anharmonic function is equal to or above the efficacy threshold, method 800 may proceed to operation 814, where the processor evaluates whether the moisture levels within the cavity have been reduced to equal to or below the moisture threshold based on the measured one or more environmental conditions. For example, when processor 202 determines that anharmonic function driving loudspeaker 710 is adequately addressing the moisture levels within cavity 700, processor 202 may evaluate whether the moisture levels within cavity 700 have been reduced to equal to or below the maximum allowable moisture in cavity 700 based on the one or more environmental conditions measured by sensor 720. In some examples, the processor may compare the one or more environmental conditions measured by the sensors (e.g., moisture levels) against the moisture threshold to determine whether the loudspeaker driven by the anharmonic function has mitigated moisture within the cavity to acceptable levels.

In some examples, when the processor determines that the moisture levels within the cavity are not equal to or below the moisture threshold, method 800 may return to operation 808, where the one or more sensors within the cavity measure one or more environmental conditions within the cavity. For example, when processor 202 determines that the moisture levels within cavity 700 are not equal to or below the maximum allowable moisture in cavity 700, processor 202 may continue driving loudspeaker 710 with the anharmonic function and may wait for sensor 720 to provide new data on the one or more environmental conditions within cavity 700.

In some examples, when the processor determines that the moisture levels within the cavity are equal to or below the moisture threshold, method 800 may proceed to operation 816, where the processor ceases to drive the loudspeaker with the anharmonic function, effectively halting the induction of directional airflow within the cavity. For example, when processor 202 determines that the moisture levels within cavity 700 are equal to or below the maximum allowable moisture in cavity 700, processor 202 may cease driving loudspeaker 710 with the anharmonic function and wait for new data from sensor 720. In some examples, following the processor ceasing to drive the loudspeaker with the anharmonic function, method 800 may return to operation 802, where the one or more sensors detect the moisture levels within the cavity of the electronic device and relay the collected data to the processor.

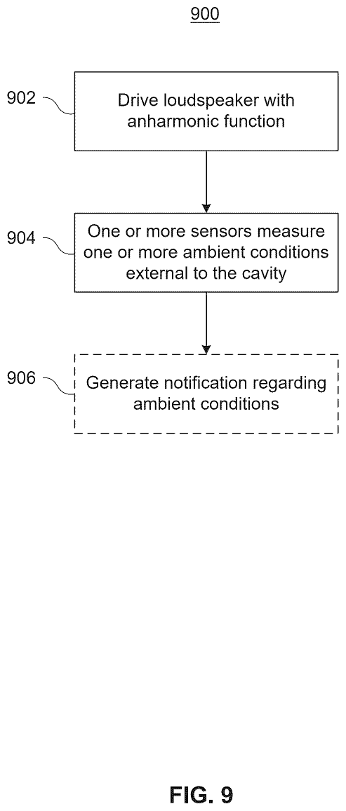

FIG. 9 illustrates a flow diagram of an example method 900 for measuring external ambient conditions using one or more sensors within the cavity and an induced airflow. It should be understood that while method 900 is described below with reference to components and configurations from FIG. 7, various other components, configurations, and electronic devices may employ method 900 to achieve similar objectives.

In some examples, at operation 902, the processor initiates a process to drive a loudspeaker disposed within the cavity with an anharmonic function. For example, processor 202 may initiate a process to drive loudspeaker 710 with an anharmonic function, such as sawtooth waveform 510 of FIG. 5. In some examples, the processor may adjust the anharmonic function based on data collected by one or more sensors. For instance, the processor may generate the anharmonic function by determining one or more characteristics of the anharmonic function (e.g., frequency, amplitude, waveform shape, phase shift, or duty cycle) to increase or decrease the net airflow or air speed through the cavity (e.g., to allow the one or more sensors to provide more accurate readings). As another example, the processor may select the anharmonic function from one or more anharmonic functions that have been predefined for specific operational modes or conditions of the electronic device.

In some examples, following the initiation of the anharmonic drive of the loudspeaker, at operation 904, the one or more sensors within the cavity measure one or more environmental or ambient conditions external to the cavity, as described in greater detail with respect to FIG. 7. For example, following the initiation of the anharmonic drive of loudspeaker 710, sensor 720 may assess one or more environmental conditions external to cavity 700. In some examples, the one or more sensors measure ambient conditions external to the cavity by analyzing the characteristics of air entering the cavity due to the induced net airflow. Some examples of ambient conditions external to the cavity include, but are not limited to, temperature, humidity, particulate composition, carbon dioxide level, oxygen level, noxious gas level, pollen count, or smoke density. In some examples, at operation 906, the processor generates a notification to alert a user of the electronic device when one or more characteristics of the air entering the cavity require their attention (e.g., dangerous conditions when the ambient temperature is above a threshold (e.g., 40° C., 42.5° C., 45° C., etc.) or noxious gases are detected, or health concerns when pollen count and/or smoke density are above a threshold).

In some examples, inducing a net airflow within the cavity by driving the loudspeaker with an anharmonic function facilitates the measurement of external ambient conditions by ensuring a continuous exchange of air between the external environment and the internal cavity. This exchange allows the one or more sensors within the cavity to sample fresh air from outside the cavity, providing accurate and real-time data on external conditions while the one or more sensors are secured within the cavity. In some examples, the controlled movement of air clears any stagnant air within the cavity that may contain residuals from previous measurements, thereby reducing potential measurement errors or delays in detecting changes in the external environment. In some examples, by manipulating the airflow characteristics (e.g., flow rate, direction, and speed) using different anharmonic functions, the device balances the inflow of external air based on the specific environmental sensing needs. For instance, different flow rates may be advisable for detecting changes in weather conditions or monitoring hazardous gases.

In some examples, the one or more sensors within the cavity are positioned and calibrated to differentiate between internal conditions and external ambient conditions. This setup ensures that data collected reflects the environment outside the device rather than conditions within the cavity, which may be influenced by internal heat sources or other components. For example, the one or more sensors may be positioned near air entry points (e.g., ports 702a and/or 702b) to directly interact with incoming air. In some examples, the processor can distinguish when fresh external air is entering the cavity by analyzing sensor data timed with specific phases of the anharmonic function driving the loudspeaker. By synchronizing the sensor readings with the periods when the loudspeaker is actively drawing in air from outside the cavity (e.g., during rapid transition 504 from Vmax to Vmin of sawtooth waveform 510 of FIG. 5), the processor can accurately determine that the data reflects external conditions. In some examples, the one or more sensors within the cavity are configured to active and measure external ambient conditions only when fresh air is drawn into the cavity. For instance, a sensor could be set to trigger ambient measurements only during the rapid intake phase of the loudspeaker's anharmonic cycle. Additionally or alternatively, a designated airflow sensor within the cavity may detect the influx of fresh air, and the processor may activate the remaining sensors as a result. For instance, upon detecting a rapid increase in airflow, an airflow sensor of sensor 720 may signal other environmental sensors of sensor 720 to commence measurements of environmental conditions (e.g., temperature, humidity, and/or particulate matter), ensuring that all readings reflect the conditions of the newly introduced air.

In some examples, a feedback loop is established between the one or more sensors and the processor to optimize the measurement of external ambient conditions. For example, as sensor 720 collects data on the air entering cavity 700, sensor 720 transmit this information to processor 202. Processor 202 may then analyze these data to assess an effectiveness of the current anharmonic function in terms of achieving desired environmental sampling conditions (e.g., sampling conditions above a certain threshold). If necessary, processor 202 may then adjust the anharmonic function by modifying one or more characteristics (e.g., frequency, amplitude, and/or waveform) to alter the air intake so that the environmental sampling conditions exceed a certain threshold. For instance, processor 202 may adjust the anharmonic function to increase the airflow rate (e.g., by increasing the amplitude of the waveform) if the initial air sampling indicates that particulate matter concentrations are below a critical detection threshold (e.g., 10 μg/m³), ensuring sufficient air volume is sampled for accurate assessments. As another example, if data from sensor 720 indicates a rapid increase in temperature, processor 202 may adjust the anharmonic function to promote a faster exchange of air within cavity 700 (e.g., by increasing the frequency of the waveform) to ensure the rapid increase in temperature corresponds to an increase in external ambient temperature and is not a result of heat accumulation inside cavity 700.

In some examples, the processor is designed to respond adaptively to changes in external ambient conditions in real-time, enhancing the functionality and efficiency of environmental monitoring. For instance, upon detecting an increase in external humidity levels that could affect the internal components, the processor may adjust the anharmonic function to increase airflow, thereby facilitating faster removal of moist air from the cavity. This immediate response not only protects the internal components from potential humidity damage but also ensures that the measurements of external conditions are not skewed by prolonged exposure to internal moisture. As another example, in response to detected changes in particulate matter or noxious gases, the processor can adjust airflow patterns to optimize the capture and analysis of these contaminants, thereby maintaining the accuracy and reliability of environmental data collected by the sensors.

Therefore, according to the above, some examples of the disclosure are directed to an electronic device. The electronic device includes a cavity including a first port and a second port. The first port has a first pneumatic resistance and the second port has a second pneumatic resistance, different from the first pneumatic resistance at different air speeds. The electronic device includes a loudspeaker disposed at least partially in the cavity. The loudspeaker is configured to be driven by an anharmonic function to induce a turbulent airflow, resulting in air entering the cavity through the first port and exiting the cavity through the second port.

Additionally or alternatively to one or more of the examples disclosed above, in some examples, the first port includes a mesh and the second port does not include a mesh. Additionally or alternatively to one or more of the examples disclosed above, in some examples, the difference in the first pneumatic resistance and the second pneumatic resistance is smaller than a turbulence pneumatic resistance threshold during laminar airflow and larger than the turbulence pneumatic resistance threshold during the turbulent airflow.

Additionally or alternatively to one or more of the examples disclosed above, in some examples, the first port includes a first mesh with a first permeability and the second port includes a second mesh with a second permeability different than the first permeability.

Additionally or alternatively to one or more of the examples disclosed above, in some examples, the first port includes a conduit disposed within the cavity. Additionally or alternatively to one or more of the examples disclosed above, in some examples, the conduit has an internal surface roughness characterized by a pattern or texture designed to disrupt laminar airflow and induce the turbulent airflow at air speeds that meet or exceed a critical velocity. Additionally or alternatively to one or more of the examples disclosed above, in some examples, the first port includes a conical conduit disposed within the cavity in a manner to induce the turbulent airflow at air speeds that exceed a critical velocity.

Additionally or alternatively to one or more of the examples disclosed above, in some examples, the first port has a first dimension and the second port has a second dimension, different from the first dimension.

Additionally or alternatively to one or more of the examples disclosed above, in some examples, the anharmonic function is a sawtooth waveform. Additionally or alternatively to one or more of the examples disclosed above, in some examples, the anharmonic function is configured to induce a combination of a laminar airflow and the turbulent airflow through the first and second ports by controlling a speed and pattern of movement of the loudspeaker. Additionally or alternatively to one or more of the examples disclosed above, in some examples, the anharmonic function operates at a frequency below 20 Hz or above 20 KHz. Additionally or alternatively to one or more of the examples disclosed above, in some examples, the anharmonic function includes a first period corresponding to a slower retraction of a diaphragm of the loudspeaker and a second period corresponding to a faster outward movement of the diaphragm.

Additionally or alternatively to one or more of the examples disclosed above, in some examples, the faster outward movement of the diaphragm induces the turbulent airflow in at least one of the first and second ports.

Additionally or alternatively to one or more of the examples disclosed above, in some examples, the anharmonic function includes a first anharmonic function when operating in a first mode and includes a second anharmonic function different from the first anharmonic function when operating in a second mode different from the first mode.

Additionally or alternatively to one or more of the examples disclosed above, in some examples, the electronic device includes one or more sensors disposed in the cavity for determining whether to operate in the first mode or the second mode.

Additionally or alternatively to one or more of the examples disclosed above, in some examples, the anharmonic function is configured as a harmonic stack, with phases of one or more waveforms of the harmonic stack synchronized such that ascending segments of the one or more waveforms occur concurrently to induce the turbulent airflow.

Additionally or alternatively to one or more of the examples disclosed above, in some examples, the phases of the one or more waveforms of the harmonic stack are further aligned to create diffuse descending segments to induce a mitigated laminar airflow in both the first and second ports.

Additionally or alternatively to one or more of the examples disclosed above, in some examples, the loudspeaker is configured to expel liquid from the cavity.

Additionally or alternatively to one or more of the examples disclosed above, in some examples, the electronic device includes one or more sensors disposed within the cavity configured to assess ambient environmental conditions external to the device by analyzing air that enters the cavity as a result of the induced airflow. Additionally or alternatively to one or more of the examples disclosed above, in some examples, the one or more sensors are configured to determine one or more of an ambient temperature, an ambient humidity, and an ambient air composition. Additionally or alternatively to one or more of the examples disclosed above, in some examples, the one or more sensors are configured to monitor airflow within the cavity, and the loudspeaker is configured to adjust one or more characteristics of the anharmonic function based on the monitored airflow to adjust a characteristic of the airflow.

Additionally or alternatively to one or more of the examples disclosed above, in some examples, a threshold effectiveness of the airflow within the cavity is determined based on an intended objective of the device.

Additionally or alternatively to one or more of the examples disclosed above, in some examples, the loudspeaker is configured to simultaneously produce sound and induce the turbulent airflow.

Some examples are directed to a method. In some examples, the method is performed at an electronic device including a cavity with a first port and a second port and a loudspeaker disposed at least partially in the cavity. The first port has a first pneumatic resistance and the second port has a second pneumatic resistance, different from the first pneumatic resistance at different air speeds. In some examples, the method includes detecting a moisture level within the cavity. In some examples, the method includes, in response to detecting the moisture level, in accordance with a determination that the moisture level is greater than a threshold moisture level, driving the loudspeaker with an anharmonic function configured to induce a turbulent airflow within the cavity.

Additionally or alternatively to one or more of the examples disclosed above, in some examples, the method includes, while driving the loudspeaker with the anharmonic function configured to induce the turbulent airflow within the cavity, detecting one or more environmental conditions within the cavity. The one or more environmental conditions include a respective moisture level. In some examples, the method includes, in response to detecting the one or more environmental conditions, in accordance with a determination that an efficacy of the anharmonic function in modifying the one or more environmental conditions is at or above a benchmark efficacy for the one or more environmental conditions, continuing to drive the loudspeaker with the anharmonic function. In some examples, the method includes, in response to detecting the one or more environmental conditions, in accordance with a determination that the efficacy of the anharmonic function in modifying the one or more environmental conditions is below the benchmark efficacy for the one or more environmental conditions, adjusting one or more characteristics of the anharmonic function based on the one or more environmental conditions and the efficacy of the anharmonic function to determine a respective anharmonic function and driving the loudspeaker with the respective anharmonic function.

Additionally or alternatively to one or more of the examples disclosed above, in some examples, the method includes, while driving the loudspeaker with the anharmonic function configured to induce the turbulent airflow within the cavity, detecting a respective moisture level within the cavity. In some examples, the method includes, in response to detecting the respective moisture level, in accordance with a determination that the moisture level is greater than a respective threshold moisture level, continuing to drive the loudspeaker with the anharmonic function. In some examples, the method includes, in response to detecting the respective moisture level, in accordance with a determination that the moisture level is at or below the respective threshold moisture level, ceasing to drive the loudspeaker with the anharmonic function.

Additionally or alternatively to one or more of the examples disclosed above, in some examples, the method includes, while driving the loudspeaker with the anharmonic function configured to induce the turbulent airflow within the cavity, detecting, via one or more sensors disposed within the cavity, one or more environmental conditions external to the cavity. In some examples, the method includes, in response to detecting the one or more environmental conditions external to the cavity, in accordance with a determination that at least one or more of the one or more environmental conditions external to the cavity exceed one or more thresholds, initiating a process to notify a user of the electronic device of the at least one or more of the one or more environmental conditions external to the cavity.

Some examples are directed to a method. The method includes measuring external ambient conditions using one or more sensors and an induced airflow within the cavity of an electronic device (e.g., using the above electronic device). Some examples are directed to a method. The method includes moisture detection and regulation within the cavity of an electronic device (e.g., using the above electronic device). Some examples of the disclosure are directed to a non-transitory computer readable storage medium. The non-transitory computer readable storage medium stores one or more programs, the one or more programs comprising instructions, which when executed by one or more processors of a mobile device, cause the electronic device to perform any of the above disclosed methods. Some examples of the disclosure are directed to an information processing apparatus for use in an electronic device. The information processing apparatus comprises means for performing any of the above disclosed methods.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. An electronic device, comprising:
a cavity comprising a first port and a second port, wherein the first port has a first pneumatic resistance and the second port has a second pneumatic resistance, different from the first pneumatic resistance at different air speeds; and
a loudspeaker disposed at least partially in the cavity, wherein the loudspeaker is configured to be driven by an anharmonic function to induce a turbulent airflow, resulting in air entering the cavity through the first port and exiting the cavity through the second port.

2. The electronic device of claim 1, wherein the first port includes a mesh and the second port does not include a mesh.

3. The electronic device of claim 1, wherein the difference in the first pneumatic resistance and the second pneumatic resistance is smaller than a turbulence pneumatic resistance threshold during laminar airflow and larger than the turbulence pneumatic resistance threshold during the turbulent airflow.

4. The electronic device of claim 1, wherein the first port includes a first mesh with a first permeability and the second port includes a second mesh with a second permeability different than the first permeability.

5. The electronic device of claim 1, wherein the first port includes a conduit disposed within the cavity with an internal surface roughness characterized by a pattern or texture designed to disrupt laminar airflow and induce the turbulent airflow at air speeds that meet or exceed a critical velocity.

6. The electronic device of claim 1, wherein the first port includes a conical conduit disposed within the cavity in a manner to induce the turbulent airflow at air speeds that exceed a critical velocity.

7. The electronic device of claim 1, wherein the first port has a first dimension and the second port has a second dimension, different from the first dimension.

8. The electronic device of claim 1, wherein the anharmonic function is configured to induce a combination of a laminar airflow and the turbulent airflow through the first and second ports by controlling a speed and pattern of movement of the loudspeaker.

9. The electronic device of claim 1, wherein the anharmonic function operates at a frequency below 20 Hz or above 20 kHz.

10. The electronic device of claim 1, wherein the anharmonic function includes a first period corresponding to a slower retraction of a diaphragm of the loudspeaker and a second period corresponding to a faster outward movement of the diaphragm, wherein the faster outward movement of the diaphragm induces the turbulent airflow in at least one of the first and second ports.

11. The electronic device of claim 1, further comprising one or more sensors disposed in the cavity for determining whether to operate in a first mode or a second mode, different from the first mode, wherein the anharmonic function includes a first anharmonic function when operating in the first mode and includes a second anharmonic function, different from the first anharmonic function, when operating in the second mode.

12. The electronic device of claim 1, wherein the anharmonic function is configured as a harmonic stack, with phases of one or more waveforms of the harmonic stack synchronized such that ascending segments of the one or more waveforms occur concurrently to induce the turbulent airflow and descending segments of the one or more waveforms are diffused to induce a mitigated laminar airflow in both the first and second ports.

13. The electronic device of claim 1, wherein the loudspeaker is configured to expel liquid from the cavity.

14. The electronic device of claim 1, further comprising one or more sensors disposed within the cavity configured to assess ambient environmental conditions external to the device by analyzing air that enters the cavity as a result of the induced airflow, wherein the one or more sensors are configured to determine one or more of an ambient temperature, an ambient humidity, and an ambient air composition.

15. The electronic device of claim 14, wherein the one or more sensors are configured to monitor airflow within the cavity, and the loudspeaker is configured to adjust one or more characteristics of the anharmonic function based on the monitored airflow to adjust a characteristic of the airflow.

16. The electronic device of claim 1, wherein the loudspeaker is configured to simultaneously produce sound and induce the turbulent airflow.

17. A method comprising:
at an electronic device comprising a cavity with a first port and a second port and a loudspeaker disposed at least partially in the cavity, wherein the first port has a first pneumatic resistance and the second port has a second pneumatic resistance, different from the first pneumatic resistance at different air speeds:
detecting a moisture level within the cavity; and
in response to detecting the moisture level:
in accordance with a determination that the moisture level is greater than a threshold moisture level, driving the loudspeaker with an anharmonic function configured to induce a turbulent airflow within the cavity.

18. The method of claim 17, further comprising:
while driving the loudspeaker with the anharmonic function configured to induce the turbulent airflow within the cavity:
detect one or more environmental conditions within the cavity, wherein the one or more environmental conditions include a respective moisture level; and
in response to detecting the one or more environmental conditions: −in accordance with a determination that an efficacy of the anharmonic function in modifying the one or more environmental conditions is at or above a benchmark efficacy for the one or more environmental conditions, continuing to drive the loudspeaker with the anharmonic function; and
in accordance with a determination that the efficacy of the anharmonic function in modifying the one or more environmental conditions is below the benchmark efficacy for the one or more environmental conditions, adjusting one or more characteristics of the anharmonic function based on the one or more environmental conditions and the efficacy of the anharmonic function to determine a respective anharmonic function and driving the loudspeaker with the respective anharmonic function.

19. The method of claim 17, further comprising:
while driving the loudspeaker with the anharmonic function configured to induce the turbulent airflow within the cavity:
detect a respective moisture level within the cavity; and
in response to detecting the respective moisture level:
in accordance with a determination that the moisture level is greater than a respective threshold moisture level, continuing to drive the loudspeaker with the anharmonic function; and
in accordance with a determination that the moisture level is at or below the respective threshold moisture level, ceasing to drive the loudspeaker with the anharmonic function.

20. The method of claim 17, further comprising:
while driving the loudspeaker with the anharmonic function configured to induce the turbulent airflow within the cavity:
detect, via one or more sensors disposed within the cavity, one or more environmental conditions external to the cavity; and
in response to detecting the one or more environmental conditions external to the cavity:
in accordance with a determination that at least one or more of the one or more environmental conditions external to the cavity exceed one or more thresholds, initiating a process to notify a user of the electronic device of the at least one or more of the one or more environmental conditions external to the cavity.
